(19) United States
(12) Patent Application Publication
(10) Pub. No.: US 2013/0092261 A1
(43) Pub. Date: Apr. 18, 2013

(54) CHECK VALVE

(71) Applicant: Allan Bo Andersson, Cambridge, NY (US)

(72) Inventor: Allan Bo Andersson, Cambridge, NY (US)

(73) Assignee: FLOMATIC CORPORATION, Glens Falls, NY (US)

(21) Appl. No.: 13/272,792

(22) Filed: Oct. 13, 2011

(51) Int. Cl. F16K 15/00

(52) U.S. Cl. 137/511; 251/336

(57) ABSTRACT

A check valve is provided capable of reducing the effects of fluid hammer and is easily replaceable and repairable. In one aspect of the invention, a check valve includes a housing with a passage having a check valve positioned therein to permit fluid flow in one direction while preventing fluid flow in the reverse direction. The housing includes an inlet port and a valve seat. The check valve includes a valve disc connected to a stem. The valve disc moves from a closed position engaged with the valve seat to an open position disengaged from the valve seat. The distance traveled by the valve disc away from the valve in a full open position is less than twenty five percent of the diameter of the inlet port.

### TECHNICAL FIELD

The invention relates generally to fluid valves, and more specifically, to check valves that reduce water hammer.

### BACKGROUND OF THE INVENTION

A sudden change in the flow velocity in pipes may result in pipe noise, pipe vibration and distinct “hammering” pipe sounds known as “water hammer.” Water hammer is the generation of energy resulting from the effect of high pressure shock waves (transient) in relatively incompressible fluids like water. Water Hammer is caused by the shock waves that are generated when a fluid is suddenly stopped abruptly in a pipe by a quick closure of a valve, pump failure or other sudden changes in the distribution piping system. Incompressible fluids, such as water, generate the greatest amount of fluid hammer, and can cause the most damage to pipes and pipe systems. These quick hydraulic shock waves can result in breakage of valves, pipe fittings, pipe supports, pump equipment damage and ruptured pipes. Higher pipe flow velocities are more susceptible to the risks of water hammer.

The higher the pipe flow velocities are the faster the weight of liquid moves, which results in a higher energy absorption when the fluid comes to rest. This is similar to a high speed train coming to a stop at a rail station or a large oil tanker coming into a port. The mass of the liquid in the pipe multiplied by the speed equals the energy that has to be absorbed when the flow stops. The resulting high pressure waves traveling about three thousand, seven hundred and fifty feet per second in a steel pipe act against the piping and the valve.

Theoretically, for every one foot per second change in flow velocity, fifty four pounds per square inch of shock is created. When a flow velocity of 9.6 feet per second (or a flow of 1,500 gallons per minute) comes to an abrupt and sudden stop in an eight inch steel pipe, a pressure surge or “water hammer” effect of 518.4 psi (above the normal pipe system pressure) results. This can cause severe stress on the pumping equipment, valve, fittings and the whole piping system. If the system is not designed to withstand these high transient forces, the pipe could rupture and/or components in the system could be damaged, including the valves. Valves are subject to potential damage both from water hammer as well as wear from use. This damage reduces the effectiveness of valves. Damage and routine maintenance of pipes and valves often require the temporary removal or permanent replacement of a section of pipe or a valve from a system.

Attempts have been made in the past to the design of valves to address the effects of hydraulic shocks or water hammer, but not very effectively. For example, traditional swing check valves use a hinged clapper that slams against a straight or slanted valve seat. These clappers rely on gravity to close by swinging open and close at a pivot point at one end of the clapper. Swing check valves close unassisted only by gravity of the clapper and when the fluid being pumped returns. The distance at which the swing valve clapper fully opens to where it fully closes is significant and causes significant water hammer. When the swing check valve finally closes, it abruptly stops the flow and causes a pressure surge resulting in shock waves. These shock waves continue until the energy generated from this sudden action dissipates.

As another example, tilted disc type check valves use a clapper hinged at a mid-point in an attempt to reduce the distance the clapper traveled when flow stops. For higher pipe flow velocities and faster closing speeds, the tilted head check valves can be assisted with a closing force from an external air cylinder that is supplied with air from a pressurized air cylinder equipped with an adjustable air valve. The air cylinder exercise a force on the valve disc thru a linkage system that exposed directly in the valves flow way. The final disc closure, in a tilted disc type check valve is dampened, just before closure with a field adjustable oil cylinder reducing disc to valve seat slamming. However, tilted head check valve, the current common art for higher velocity pumping systems are difficult to install and adjust because of the number of valve part components, multiple valve seats and bearing surfaces that require periodic maintenance and if not could and often do fail. Tilted head check valves are also difficult to service internal parts without taking the whole valve apart and are difficult to handle because of their top heavy valve assembly that includes pressurized air tank and an oil tank. The angled valve seat surfaces are vulnerable to wear and are difficult to field repairs. The tilted disc valve or swing check valve can not be rotated on its axis or installed in vertical direction without modifications to the external assisted closing system.

### SUMMARY OF THE INVENTION

The shortcomings of the prior art may be alleviated by using a check valve in accordance with one or more principles of the present invention. The check valve may be used in any type of hydraulic or other fluid flow lines that is concerned with water hammer such as, for example, high velocity flow pipes. The valve can be rotated on its axis installed in any direction, horizontal or vertical.

In one aspect of the invention, a valve assembly comprises a housing, with a passage formed through the valve assembly, the housing includes an inlet port with an inlet port diameter and an outlet port, a valve seat within the passage between the inlet and outlet ports, and a valve positioned in the passage of the housing, including a stem extending from a valve disc, the valve disc engaging the valve seat and moveable between a closed position and a fully open position, the valve disc being resiliently biased to the closed position to inhibit fluid flow in a first direction and allowing fluid flow in the direction opposite the first direction, where the valve disc travels a maximum distance from the fully open position to the closed position is less distance than twenty-five percent of the inlet port diameter. In another embodiment of the valve assembly, the valve disc travels a maximum distance from the closed position to the fully open position that is less than twenty percent of the inlet port diameter. In another embodiment of the invention, the valve disc travels a maximum distance from the closed position to the fully open position that is less than fifteen percent of the inlet port diameter. In still another embodiment of the invention, the housing includes an inlet extender removably attached to the housing, where the inlet port diameter is defined by the inlet port of the extender.

In another aspect of the invention, a valve assembly comprises a housing with a passage defined therethrough, including a first end with a diameter and a second end where fluid passes through the passage from the first end to the second, an extender defining a passage in fluid communication with the passage of the housing, the extender includes an inlet port with a diameter and an outlet port, the outlet port having a diameter that is larger than the extender inlet port and substantially the same as the diameter of the first end of the housing, a valve seat within the passage between the first end and the second end, and a valve positioned in the passage of the housing, and including a stem which extends from a valve disc, which engages a valve seat, is movable between a closed position and a fully open position, and is resiliently biased in the closed position to inhibit the fluid flow in a first direction, and allow fluid flow in an opposite direction to the first direction, where the head travels a maximum distance from the closed position to the fully open position of less than twenty-five percent of the inlet port diameter of the extender. In another embodiment, the head travels a maximum distance from the closed position to the fully open position that is less than twenty percent of the inlet port diameter of the extender. In another embodiment, the head travels a maximum distance from the closed position to the fully open position that is less than fifteen percent of the inlet port diameter of the extender. In another embodiment of the invention, the valve disc travels a maximum distance from the closed position to the fully open position that is less than ten percent of the inlet port diameter of the extender.

In another aspect of the invention, a valve assembly includes a housing defining a passage therethrough, having a first end with a diameter and a second end where fluid passes through the passage from the first end to the second end, an extender removably attached to the housing near the first end of the housing, the extender defining a passage in fluid communication with the passage of the housing, where the extender includes an inlet port with a diameter and an outlet port with a diameter lager than the extender inlet port diameter and substantially the same as the diameter of the first end of the housing, a valve seat within the passage between the first end and the second end, the valve seat defining a diameter, and a valve positioned in the passage of the housing, the valve including a stem extending from the valve disc and the valve disc engaging the valve seat and moveable between a closed position to a fully open position, the valve disc being resiliently biased in the close position to inhibit fluid flow in a first direction and allowing fluid flow in a direction opposite to the first direction, where the valve seat diameter is smaller than the inlet port of the extender.

In another aspect of the invention, a check valve includes a housing defining a passage, including an inlet port and an outlet port, the inlet port having an inlet port diameter, a valve seat within the passage between the inlet and outlet ports, the valve seat defining a diameter, and a valve positioned in the passage of the housing, the valve including a stem extending from the valve disc, the valve disc engaging the valve seat and moveable between a closed position and a fully open position, the valve disc being resiliently biased in the closed position to inhibit fluid flow in a first direction and allow fluid flow in an opposite direction to the first direction, where the inlet port diameter of the housing is smaller than the valve seat diameter.

Other additional features and benefits will become apparent from the following drawings and descriptions of the invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the end of the specification. The foregoing and other objects, features, and advantages of the invention are apparent from the following detailed description taken in conjunction with the accompanying drawings in which:

FIG. 1 is a perspective view of one embodiment of the check valve, in accordance with an aspect of the invention;

FIG. 2 is a cross sectional view of the check valve of FIG. 1 along line 2-2, in accordance with an aspect of the invention;

FIG. 3 is a cross sectional view of an alternative embodiment of the check valve of FIG. 1 along line 3-3, in accordance with an aspect of the invention.

### DETAILED DESCRIPTION FOR CARRYING OUT THE INVENTION

Presented herein is an improved check valve that provides quicker closing action, low head inertia and shorter travel distance of the valve disc resulting in better dynamic non-water slamming response. A check valve constructed in accordance with one or more principles of the present invention will provide lower operating and maintenance costs because of the resulting reduction of shock waves created by the abrupt closure of the valve. For the purposes of promoting an understanding of the principles of the check valve, reference will now be made to the embodiments, or examples, illustrated in the drawings and specific language will be used to describe these. It will nevertheless be understood that no limitation of the scope of the invention is thereby intended. Any alterations and further modifications in the described embodiments, and any further applications of the principles of the invention as described herein are contemplated as would normally occur to one skilled in the art to which the check valve invention relates.

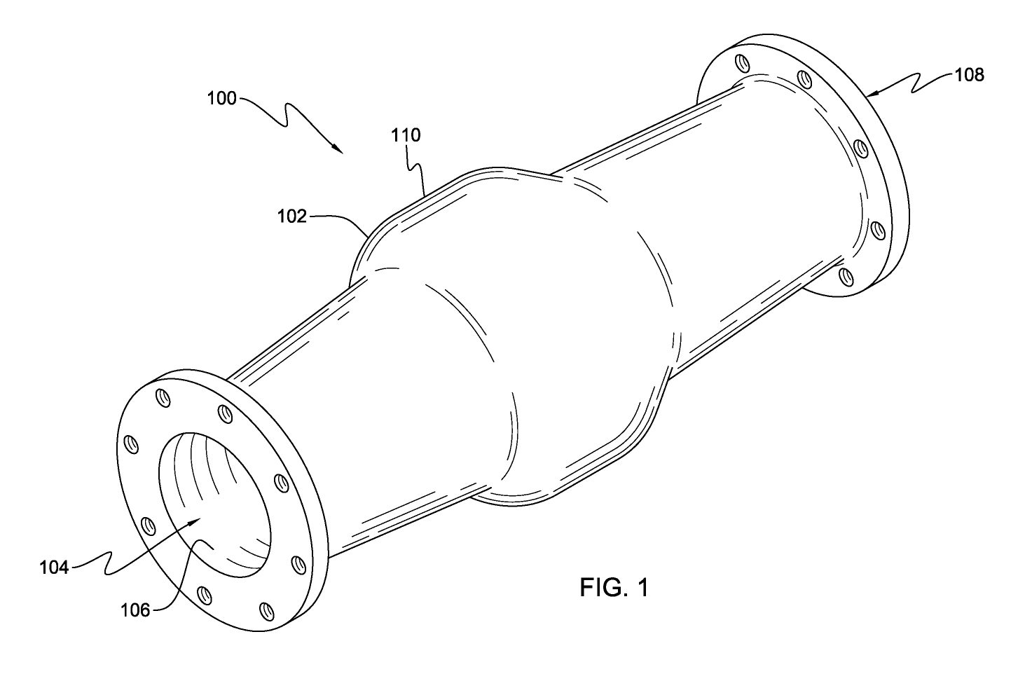

Referring now to FIG. 1, a valve assembly 100 in accordance with the principles of the present invention includes a housing 102 defining a passage 104. The housing 102 includes an inlet port 106 or opening and an outlet port 108 or opening that define the beginning and end of a water flow path through the passage 104 of the housing 102. A check valve 110 is located within housing 102 between inlet port 106 and outlet port 108 to permit fluid flow from inlet port 106 to outlet port 108, while preventing fluid flow in the reverse direction.

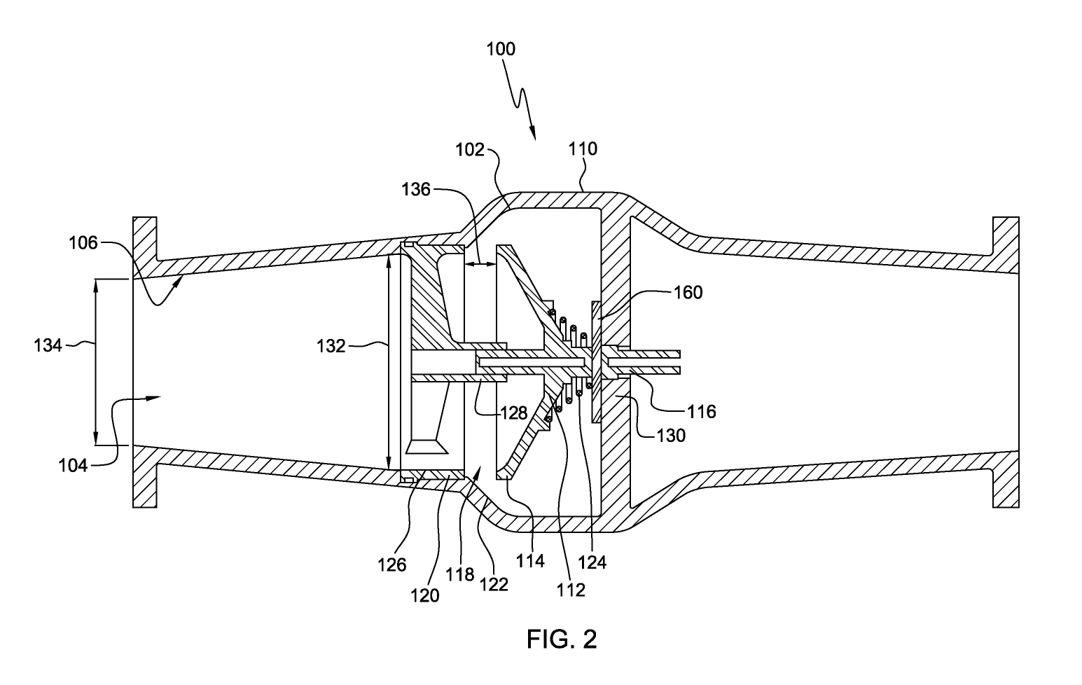

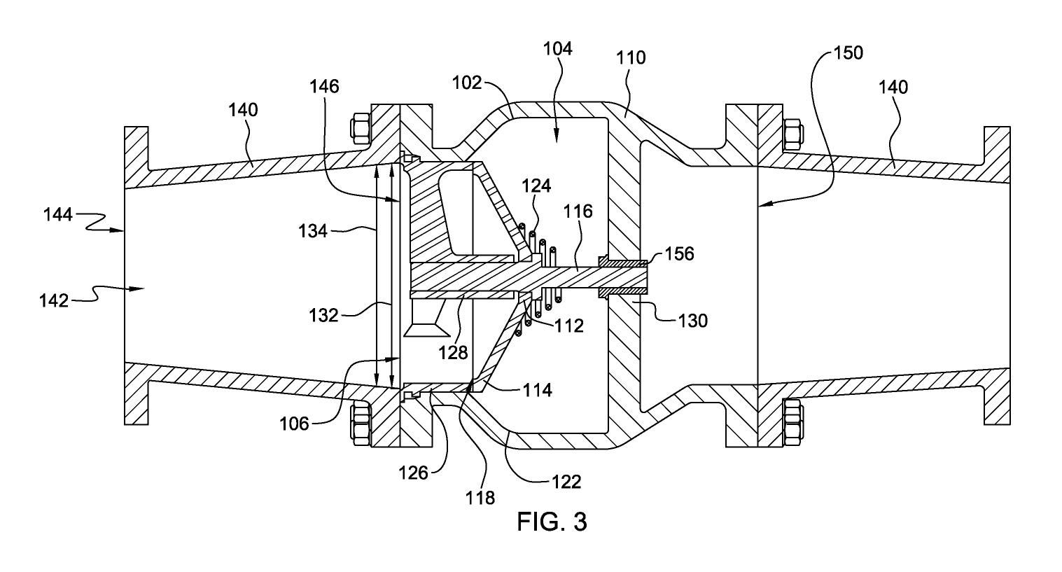

A valve assembly 100 constructed in accordance with the principles of the present invention is generally shown in FIG. 2 and FIG. 3. Valve assembly 100 of FIG. 2 is shown where a valve disc 112 is in a fully open position. Valve assembly 100 of FIG. 3 is shown where valve disc 112 is in a closed position. Valve assembly 100 is configured such that the effects of water hammer are minimized when the flow of fluid stops and valve disc 112 moves to a closed position. Check valve 110 includes a valve disc 112 including a disc valve seat 114 and a center stem 116. Disc valve seat 114 of valve disc 112 mates with a valve aperture 118 or opening formed by, for example, a flange on an inner surface 122 of housing 102 of the check valve 110. Valve disc 112 opens and closes depending on the pressure differential upstream and downstream of check valve 110. A spring 124 ensures reliable operation and biases check valve 110 in a closed position, such that gravity and/or air/oil cylinders are not required. Valve disc disc 112 may be kept against valve seat 126 by the pressure exerted by spring 124. In order for the flow of fluid to begin or resume through the valve, the pressure of the fluid must overcome the pressure exerted by spring 124. For stable inline service, valve disc 112 and valve stem 116 are guided both on the in-let and the outlet side of the valve seat 126 by an inlet valve guide 128 and an outlet valve guide 130, allowing precise head and seat alignment.

As the forward velocity of the fluid increases, the fluid pushes against the valve disc 112 and unseats the valve disc 112 from the valve seat 126 to permit fluid to flow through the check valve 110. Alternatively, as the forward velocity of the fluid slows, the spring 124 biases the valve disc 112 to close before the fluid flow completely reverses. In current designs, the diameter 132 of the valve aperture 118 is the same or substantially the same as the diameter of the nominal pipe size or, alternatively, the diameter 134 of the inlet port 106 or opening. In these designs, the valve opening 136, or the distance the valve disc 112 travels to be considered fully opened from the valve seat 126, is equal to twenty-five percent of the diameter of the valve seat 126 opening, resulting in the same flow area as the valve seat area. For example, in current designs, the valve disc of an eight inch sized check valve, measured by the diameter of the inlet opening, travels two inches from a closed position on the valve seat to being fully open. However, current check valve construction still poses a significant risk to water hammer that could cause damage to valves, pipe fittings, pipe supports, and pump equipment.

In one aspect of the present invention, the diameter 132 of the valve seat 126 is larger than the diameter 134 of the pipe or inlet port 106 or opening. In one embodiment, the housing 102 of the check valve 110 decreases in size from the valve seat 126 to the inlet port 106. In another aspect of the present invention, the valve disc 112 travels or opens from the valve seat 126 a maximum distance less than twenty-five percent of the diameter 132 of the pipe or inlet port 106 or opening which is equal to the valve opening 136. In one embodiment, the valve disc 112 travels or opens from the valve seat 126 a maximum distance of less than twenty percent of the diameter 132 of the pipe or inlet port 106 or opening which is equal to the valve opening 136. In another embodiment, the valve disc 112 travels or opens from the valve seat 126 a maximum distance of about 15% of the diameter 132 of the pipe or inlet port 106 or opening which is equal to the valve opening 136.

In one embodiment, the check valve 110 constructed in accordance with the principles of the present invention may provide the same flow area through the valve opening 136 as a check valve 110 having an inlet port 106 and valve seat 126 with the same diameter. As an example, if the diameter 134 of the inlet port 106 decreases relative to the diameter 132 of the valve seat 126 while the valve opening 136 distance decreases to reduce and/or eliminate any water hammering effects, the diameter 132 of the valve seat 126 can be manipulated to ensure that the same flow area is provided through the valve seat 126 as a check valve 110 having an inlet port 106 and valve seat 126 with the same diameter. If the same flow area is desired, then the diameter 132 of the valve seat 126 can be calculated by squaring the inlet port 106 diameter and multiplying by pi and then dividing by the product of the valve opening 136 multiplied by pi. By increasing the diameter 132 of the valve seat 126 in accordance with the principles of the present invention, the valve seat 126 area can accommodate higher flow, while allowing the valve disc 112 to travel a shorter distance for faster closing that reduces the hydraulic water hammer effects.

In one example, if the maximum distance the valve disc 112 travels is twenty percent of the diameter 136 of the pipe or inlet port 106 or opening, then the diameter 132 of the valve seat 126 could increase to ensure the same flow area through the check valve 110. For example, if a check valve 110 has an eight inch diameter inlet port 106 or opening, then, in accordance to one aspect of the present invention, the valve opening 136 or distance the valve disc 112 travels from a fully open to closed position could be 1.6 inches, or twenty percent of the diameter 134 of the inlet port 106 to ensure that the same flow area is provided. In this example, the diameter 132 of the valve seat 126 could increase to 10 inches, which is larger than the diameter 134 of the inlet port 106. In another example, if the distance the valve disc 112 travels is 17.5 percent of the diameter of the pipe or inlet port 106 or opening, then a check valve 110 having an eight inch inlet port 106 or opening would have a valve opening 136 of 1.4 inches. In this example, the diameter 132 of the valve seat 126 could be 11.4 inches.

By decreasing the diameter of the pipe or inlet port 106 or opening and increasing the diameter 132 of the valve seat 126, the maximum travel distance of the valve disc 112 from a fully opened position to a closed position can be shortened. By decreasing the distance the valve disc 112 travels from a fully open position to closed position, the valve will already be closed by the time the forward velocity has decreased to zero. A check valve constructed in accordance with the principles of the present invention also reduced the effects of hydraulic shock or water hammer. During testing, the deceleration testing data for a check valve constructed in accordance with the principles of the present invention was better than for traditional check valves having an inlet port diameter equal to the valve seat diameter. At the same flow rate of about 1,200 gpm (7.7 feet per second), the reverse pressure increase was about 17% to 40% lower dependent on closing speed (0.33 seconds to 0.07 seconds). In addition at 1,500 gpm flow rate (9.6 feet per second flow velocity, the check valve constructed in accordance with the present invention was about 24% more efficient (or less headloss).

In one embodiment, the housing 102 contains the valve components and also forms the inlet port 106 having a smaller diameter 134 than the valve seat 126 diameter, and the outlet port 108. In an alternative embodiment, an extender 140 may be permanently or removably attached by, for example, welding, bolts, or other attachment devices or means, to the housing 102 including the valve seat 126, valve disc 112. Extender 140 defines a passage 142 that is in fluid communication with the passage 104 defined by housing 102. In such an embodiment, the diameter 134 of inlet port 106 of the housing 102 could be, for example, equal to the diameter 132 of the valve seat 126.

Extender 140 includes an inlet port 144 and a second port 146 having a larger diameter than the extender inlet port 144 and the same diameter as the diameter 134 of the inlet port 106 of the housing 102 or of the valve seat 126. In one embodiment, the inlet port 144 of the extender 140 is the inlet port 106 for the valve assembly 100 in accordance with the principles of the present invention. In such an embodiment, the maximum distance the valve disc 112 travels is determined by a percentage of the diameter 134 of the inlet port 144 of the extender 140, not the inlet port 106 of the housing 102.

In one aspect of the present invention, an extender 140 removeably attached to the housing 102 allows the valve components within the housing 102 to be removed, repaired and/or replaced easily. An extender 140 may also be affixed or removably attached to an outlet port 150 of the housing 102. One or more extenders 140 of different lengths may be selected for different applications involving different fluids. The decision to select a particular length of extenders 140 may also be motivated by the difference between the inlet port 144 and second port 146 of the extender 140, with a greater difference leading to the selection of a greater length. In one embodiment, the length of the extender 140, whether integral with or removably attached to the housing 102, may be equal in length to 150% of the inlet port 144 diameter to produce more laminar flow velocities. As a result, the flow velocities across the valve seat 126 are similar to a standard valve yet at lower friction losses and quicker valve disc 112 closing.

In one embodiment, center stem 116 may be solid or hollow. In the embodiment where center stem 116 is hollow, a chamber 162 may be formed in center stem 162. Hollow center stem 116 or a solid center stem 116 made from, for example, a light weight material which reduces the overall mass of center stem 116 and valve disc 112. The lower mass of center stem 116 and valve disc 112 results in a lower inertia, in a quicker movement of valve disc 112, and quicker opening and closing speeds and times.

In accordance with another aspect of the present invention, inlet valve guide 128 and outlet valve guide 130, positioned along the longitudinal axis of check valve 110, guide center stem 116 of the check valve 110 as the valve disc 112 opens and closes. In one embodiment, outlet valve guide 130 may include a retention and guide bushing 156 surrounding a portion of outer surface of center stem 116. Valve guides 128, 130 are designed to keep the valve disc 114 in proper alignment to avoid jamming or sticking and serve as bearing surfaces for smooth passage of center stem 116 during operation.

In an alternative embodiment, a stronger spring tension can be used to increase the force applied to valve disc 112. This increase in force may result in a faster closing time of valve disc 112. A stronger spring tension can be achieved by, for example, using a spring 124 manufactured with a stronger spring tension. Alternatively, in another embodiment, tension on spring 124 may be increased by positioning a washer 160 between spring 124 and outlet valve guide 130 as shown in FIG. 2.

While embodiments of the invention have been illustrated and described in detail in the disclosure, the disclosure is to be considered as illustrative and not restrictive in character. All changes and modifications that come within the spirit of the invention are to be considered within the scope of the disclosure.

What is claimed is:

1. A check valve, said check valve comprising:
a housing defining a passage therethrough, said housing including an inlet port and an outlet port, said inlet port having an inlet port diameter;
a valve seat within the passage between the inlet and outlet ports;
a valve positioned in the passage of said housing, said valve including a stem extending from a valve disc, the valve disc engaging the valve seat and moveable between a closed position to a fully open position, the valve disc being resiliently biased in the closed position to inhibit fluid flow in a first direction and allow fluid flow in an opposite direction to the first direction, wherein the valve disc travels a maximum distance from the fully open position to the closed position of less than twenty-five percent of the inlet port diameter.

2. The check valve of claim 1, wherein the valve disc travels a maximum distance from the closed position to the fully open position of less than twenty percent of the inlet port diameter.

3. The check valve of claim 1, wherein the valve disc travels a maximum distance from the closed position to the fully open position of about fifteen percent of the inlet port diameter.

4. The check valve of claim 1, wherein said housing includes an inlet extender removeably attached to said housing, wherein the inlet port diameter is defined by an inlet port of the extender.

5. The check valve of claim 1, wherein the valve stem is hollow.

6. The check valve of claim 1, wherein the valve disc is biased to a closed position by a spring.

7. The check valve of claim 6, further comprising an inlet guide and an outlet guide, said inlet and outlet guides guide the valve stem as the valve disc moves from the closed position to the fully open position.

8. The check valve of claim 7, wherein the spring biases the valve disc in the closed position.

9. The check valve of claim 8, wherein the outlet guide is affixed to an inner surface of the housing by a support.

10. The check valve of claim 9, further comprising
a washer disposed between the support of the outlet guide and the spring, and configured to increase the tension on the spring.

11. The check valve of claim 1, wherein the valve seat defines a diameter larger than the inlet port diameter.

12. A valve assembly, said valve assembly comprising:
a housing defining a passage therethrough, said housing including a first end having a diameter and a second end, wherein fluid passages through the passage from the first end to the second end;
an extender removably attached to said housing near the first end of said housing, said extender defining a passage in fluid communication with the passage of said housing, said extender including an inlet port having a diameter and an outlet port, the outlet port having a diameter larger than the extender inlet port diameter and substantially the same as the diameter of the first end of said housing;
a valve seat within the passage between the first end and the second end;
a valve positioned in the passage of said housing, said valve including a stem extending from a valve disc, the valve disc engaging the valve seat and moveable between a closed position to a fully open position, the valve disc being resiliently biased in the closed position to inhibit fluid flow in a first direction and allow fluid flow in an opposite direction to the first direction, wherein the valve disc travels a maximum distance from the closed position to the fully open position of less than twenty-five percent of the inlet port diameter of said extender.

13. The valve assembly of claim 12, wherein the valve disc travels a maximum distance from the closed position to the fully open position of less than twenty percent of the inlet port diameter of said extender.

14. The valve assembly of claim 12, wherein the valve disc travels a maximum distance from the closed position to the fully open position of about fifteen percent of the inlet port diameter of said extender.

15. A valve assembly, said valve assembly comprising:
a housing defining a passage therethrough, said housing including a first end having a diameter and a second end, wherein fluid passages through the passage from the first end to the second end;
an extender removably attached to said housing near the first end of said housing, said extender defining a passage in fluid communication with the passage of said housing, said extender including an inlet port having a diameter and an outlet port, the outlet port having a diameter larger than the extender inlet port diameter and substantially the same as the diameter of the first end of said housing;
a valve seat within the passage between the first end and the second end, said valve seat defining a diameter;
a valve positioned in the passage of said housing, said valve including a stem extending from a valve disc, the valve disc engaging the valve seat and moveable between a closed position to a fully open position, the valve disc being resiliently biased in the closed position to inhibit fluid flow in a first direction and allow fluid flow in an opposite direction to the first direction, wherein the valve seat diameter is smaller than the inlet port of said extender.

16. A check valve, said check valve comprising:
a housing defining a passage therethrough, said housing including an inlet port and an outlet port, said inlet port having an inlet port diameter;
a valve seat within the passage between the inlet and outlet ports, said valve seat defining a diameter;
a valve positioned in the passage of said housing, said valve including a stem extending from a valve disc, the valve disc engaging the valve seat and moveable between a closed position to a fully open position, the valve disc being resiliently biased in the closed position to inhibit fluid flow in a first direction and allow fluid flow in an opposite direction to the first direction, wherein the inlet port diameter of the housing is smaller than the valve seat diameter.
